(19) United States
(12) Patent Application Publication
(10) Pub. No.: US 2024/0326074 A1
(43) Pub. Date: Oct. 3, 2024

(54) LOW GWP SPRAYABLE OR EXTRUDABLE COMPOSITION AND METHOD

(71) Applicant: Quin Global US, Inc., Omaha, NE (US)

(72) Inventors: Matthew Petersen, Omaha, NE (US); Carl Fowler, Perth (GB)

(21) Appl. No.: 18/741,552

(22) Filed: Jun. 12, 2024

Related U.S. Application Data
(63) Continuation-in-part of application No. 17/632,297, filed on Feb. 2, 2022.
(60) Provisional application No. 63/472,688, filed on Jun. 13, 2023.

(30) Foreign Application Priority Data
Aug. 9, 2019 (GB) 1911437.0

(51) Int. Cl. B05B 9/04; C09J 9/00; C09J 153/02

(52) U.S. Cl. CPC B05B 9/04; C09J 9/00; C09J 153/02

(57) ABSTRACT

A system may include a pre-pressurized canister filled with one or more polymeric materials and one or more low global warming potential (GWP) propellants. The one or more low GWP propellants may include at least one of carbon dioxide, nitrogen, or trans-1-Chloro-3,3,3-trifluoropropene. The system may include a valve sub-system including a dispensing valve configured to couple to the pre-pressurized canister and a valve control mechanism configured to regulate a pressure of the pre-pressurized canister to cause the pre-pressurized canister to release the one or more polymeric materials. The system may include a dispensing sub-system configured to fluidically couple the pre-pressurized canister to the valve sub-system. The dispensing sub-system may include a dispensing hose coupled to the dispensing valve and a dispensing member coupled to the dispensing hose. The dispensing member may be configured to dispense the one or more polymeric materials contained within the pre-pressurized canister.

### CROSS-REFERENCE TO RELATED APPLICATIONS

The present application is a continuation-in-part of U.S. patent application Ser. No. 17/632,297, filed Feb. 2, 2022, which is a National Stage application of PCT Application No. PCT/EP2020/072298, filed Aug. 7, 2020, which is an International application of United Kingdom Patent Application No. GB1911437.0, filed Aug. 9, 2019; the present application also claims the benefit of U.S. Provisional Application No. 63/472,688, filed Jun. 13, 2023; all of which are incorporated herein by reference in their entirety.

### TECHNICAL FIELD

The present disclosure relates to sprayable compositions and to a method for preparing sprayable compositions. The present disclosure further relates to reactive polymer canisters with low global warming potential (GWP) propellants.

### BACKGROUND

Adhesives are compositions which promote or facilitate the bonding of two surfaces to each other. Many types of adhesives exist, and the choice of a particular adhesive may depend on a number of factors, including, for example, the chemical and/or physical nature of the surface or surfaces to which the adhesive is applied, the intended use for the adhesive and/or the bonded product, the environment and/or conditions to which the product and/or adhesive will be exposed (e.g., temperature, pressure, humidity, etc.), and the bonding performance required for the desired application.

Adhesives may be provided in different forms, such as hot melt adhesives, pressure-sensitive adhesives, or liquid adhesives, which can be provided as a solution (e.g., solvent-based) or as a dispersion/emulsion. Adhesives can also be applied by different means, including using brushes, rollers, applicator (e.g., heat) guns, and spray devices.

An advantage of liquid adhesives for industrial applications is their ability to be used as spray adhesives. Spray adhesives can be applied to relatively large areas in a reliable, clean, and time-efficient manner.

An advantage of solvent-based adhesives is that, due to the volatility of the solvent(s), the drying time of the adhesive can be reduced or minimized. However, a disadvantage of solvent-based adhesives is that many solvents exhibit relatively high flammability, thus causing potential health and safety risks during use.

A problem in the adhesive industry is the difficulty to prepare adhesive compositions which exhibit one or more desired properties, such as high volatility and/or low flammability. This may be particularly relevant when the adhesive is a solvent-based adhesive and/or when the adhesive is provided as a spray-adhesive.

Additionally, there has been increasing pressure from national and state regulatory bodies to reduce or eliminate propellants or blowing agents that have high global warming potential (GWP). Conventionally, hydrofluorocarbons (HFCs) are used in consumer and technical aerosols. However, HFCs are powerful greenhouse gases with a high-GWP and pose a high overall risk to human health and the environment. With the increasing pressure from national and state regulatory bodies, there is an increased need for a low-GWP alternative to high-GWP HFCs.

### SUMMARY

According to a first aspect of the present disclosure there is provided a method for preparing a sprayable composition, the method comprising: (i) providing a composition in a container, where the composition includes at least one core component and at least one solvent, where the at least one core component includes at least one polymer or resin; (ii) sealing the container; (iii) providing a flammability reducer in the container; and (iv) pressurizing the container with a gas propellant.

The method may include providing steps (i)-(iv) sequentially.

The composition may comprise, may consist essentially of, or may consist of an adhesive composition, a coating composition (e.g., a paint), or a primer composition. Generally, the composition may include or may be any composition typically used as a sprayable composition.

The method may include mixing the at least one core component and at least one solvent to provide the composition.

The method may include mixing the at least one core component and at least one solvent before providing the mixture/composition in the container. Alternatively, or additionally, the method may include mixing the at least one core component and at least one solvent in the container. Advantageously, the method may include mixing the at least one core component and at least one solvent before providing the mixture in the container. By such provision, the need to provide a means for mixing the at least one core component and the at least one solvent inside the container, e.g., via stirrers, shaking devices, or the like, may be avoided.

In an embodiment, the composition may include or may be an adhesive composition. The adhesive composition may include at least one adhesive and at least one solvent. The method may include mixing the at least one adhesive and at least one solvent to provide the adhesive composition.

The method may comprise mixing the at least one adhesive and at least one solvent before providing the mixture, e.g., the adhesive composition, in the container. Alternatively, or additionally, the method may include mixing the at least one adhesive and at least one solvent in the container. Advantageously, the method may include mixing the at least one adhesive and at least one solvent before providing the mixture in the container. By such provision, the need to provide a means for mixing the at least one adhesive and the at least one solvent inside the container, e.g., via stirrers, shaking devices, or the like, may be avoided.

Typically, the container may be a sealed container, e.g., a canister. Canisters may be particularly well suited as spray-adhesives containers, e.g., for industrial applications. The container may also be an aerosol container or canister, such as a 500 mL aerosol can, or a canister such as 22 L canister or a 110 L canister.

The at least one core component, e.g., adhesive, may include a polymeric adhesive and/or a polymeric resin. The at least one core component, e.g., adhesive, may comprise, may consist essentially of, or may consist of one or more polymers selected from a thermoplastic elastomer, e.g., styrene butadiene (SBR), styrene-butadiene-styrene block copolymer (SBS), or styrene-isoprene-styrene block copolymer (SIS). An ordinary person of skill in the art will understand that other sprayable polymers or resins may be used, depending on the intended use for the composition, e.g., for the adhesive. For example, the at least one core component, e.g., adhesive, may comprise, may consist essentially of, or may consist of one or more components/polymers selected from acrylic resins, or thermoset resins such as, epoxy resins or the like.

The at least one solvent may include at least one organic solvent. The at least one solvent may comprise, may consist essentially of, or may consist of one or more solvent selected from an ester, e.g., methylacetate or ethylacetate, a ketone, e.g., methyl ethyl ketone (MEK) or acetone, or a halogenated solvent, e.g., transdichloroethylene. The at least one solvent may comprise, may consist essentially of, or may consist of transdichloroethylene. Transdichloroethylene is a solvent which exhibits relatively low flammability. An ordinary person of skill in the art will understand that other solvents may be used, depending for example, on the particular core component, e.g., adhesive, used in the composition.

The flammability reducer may comprise, may consist essentially of, or may consist of trans-1-chloro-3,3,3-trifluoropropene. The flammability reducer may be a compound of formula (I):

CF3-CH═CCIH (I)

In an embodiment, the flammability reducer, e.g., trans-1-chloro-3,3,3-trifluoropropene, may be the compound marketed as Solstice® PF-C by Honeywell®.

The gas propellant may include at least one inert gas. The gas propellant may comprise, may consist essentially of, or may consist of one or more gas selected from carbon dioxide (CO₂), nitrogen, argon, or a halogenated gas such as 1,3,3,3-tetrafluoropropene (e.g., as marketed as ‘HFO 1234ZE’ by Honeywell®) or trans-1-chloro-3,3,3-trifluoropropene (e.g., as marketed as ‘HFO 1233ZD’ by Honeywell®). Typically, the gas propellant may comprise, may consist essentially of, or may consist of carbon dioxide.

Advantageously, pressurizing the canister with a gas propellant may promote, facilitate, and/or help mixing of the flammability reducer with the composition, e.g., adhesive composition. Such mixing under pressure may provide the advantageous effect of reducing the flammability of the sprayable composition, while mitigating, minimizing, or avoiding any problem associated with its high volatility. Advantageously also, the present method may reduce or avoid the need to provide expensive or impractical mixing means to mix the flammability reducer with the composition. The method may allow the provision of a substantially homogeneous sprayable composition.

Certain flammability reducers, such as trans-1-chloro-3,3,3-trifluoropropene (Solstice® PF-C) typically are highly volatile. This makes these compounds difficult to mix in a composition, such as an adhesive composition, without them evaporating. Thus, the inventors have discovered a new process for preparing a sprayable, non-flammable, solvent-based composition.

The method may consist of the steps (i), (ii), (iii) and (iv).

In an embodiment of the first aspect, there is provided a method for preparing a sprayable composition, the method comprising: (i) providing a composition including at least one core component including least one polymer or resin, and transdichloroethylene in a container; (ii) sealing the container; (iii) providing trans-1-chloro-3,3,3-trifluoropropene in the container; and (iv) pressurising the container with a gas propellant.

The method may include providing the steps (i)-(iv) sequentially.

In another embodiment of the first aspect, there is provided a method for preparing a sprayable adhesive composition, the method comprising: (i) providing an adhesive composition including at least one adhesive and transdichloroethylene in a container; (ii) sealing the container; (iii) providing trans-1-chloro-3,3,3-trifluoropropene in the container; and (iv) pressurising the container with a gas propellant.

The method may include providing the steps (i)-(iv) sequentially.

The amount of core component or adhesive, e.g., polymer or resin, may be in the range of about 10-50 wt %, e.g., about 20-40 wt %, typically about 27-32 wt %, relative to the amount of the composition, e.g., of the adhesive composition.

The amount of solvent, e.g., transdichloroethylene, may be in the range of about 50-90 wt %, e.g., about 60-80 wt %, typically about 68-73 wt %, relative to the amount of the composition, e.g., of the adhesive composition.

The amount of flammability reducer, e.g., trans-1-chloro-3,3,3-trifluoropropene, may be in the range of about 5-50 wt %, e.g., about 10-30 wt %, typically about 18-25 wt %, relative to the amount of solvent in the composition, e.g., of the adhesive composition.

The amount of gas propellant, e.g., carbon dioxide, may be in the range of about 3-30 wt %, e.g., about 5-25 wt %, typically about 8-20 wt %, relative to the total amount of the sprayable composition. The amount of gas propellant may be determined so as to reach a desired pressure inside the container and/or a desired amount relative to the composition, e.g., adhesive composition.

Typically, the pressure in the container, e.g., canister, following injection of the gas propellant may be in the range of about 100-406 psi (e.g., about 6.9-28 bar), e.g., about 150-350 psi (e.g., about 10.3-24.1 bar), typically about 200-280 psi (e.g., about 13.8-19.3 bar).

The method includes providing the composition, e.g., adhesive composition, in the container, e.g., a predetermined amount thereof. Typically, the method may include pumping the composition, e.g., adhesive composition, in the container. Alternatively, the method may include pouring the composition, e.g., adhesive composition, in the container.

Advantageously, the method may include sealing the container before providing the flammability reducer. By such provision, the flammability reducer may be provided into the container, e.g., canister, without risk of evaporation thereof due to its high volatility.

The method may include providing the flammability reducer in the container, e.g., a predetermined amount thereof. Typically, the method may include pumping or injecting the flammability reducer in the container.

The method may include connecting an inlet of the container to a supply line, e.g., which may be connected to a supply of the gas propellant. The method may include providing, e.g., injecting, the gas propellant, e.g., a predetermined amount thereof. Injection of the gas propellant may cause pressurization of the container, which may facilitate and/or help mixing of the flammability reducer with the composition, e.g., adhesive composition. Such mixing under pressure may provide the advantageous effect of reducing the flammability of the sprayable composition, while mitigating, minimizing, or avoiding any problem associated with its high volatility. Advantageously also, the present method may reduce or avoid the need to provide expensive or impractical mixing means to mix the flammability reducer with the composition, e.g., adhesive composition.

According to a second aspect of the present disclosure there is provided a sprayable composition comprising: a composition including at least one core component including at least one polymer or resin, and at least one solvent including transdichloroethylene; a flammability reducer including trans-1-chloro-3,3,3-trifluoropropene; and a gas propellant including carbon dioxide.

The composition may include or may be an adhesive composition, a coating composition (e.g., a paint), or a primer composition. Generally, the composition may include or may be any composition typically used as a sprayable composition.

In an embodiment, the composition may include or may be an adhesive composition. Thus, according to an embodiment of the second aspect, there is provided a sprayable adhesive composition comprising: an adhesive composition including at least one adhesive including at least one polymer or resin and at least one solvent including transdichloroethylene; a flammability reducer including trans-1-chloro-3,3,3-trifluoropropene; and a gas propellant including carbon dioxide.

Typically, the adhesive composition is provided as a pressurized composition. Typically, the pressure of the composition may be in the range of about 100-406 psi (e.g., about 6.9-28 bar), e.g., about 150-350 psi (e.g., about 10.3-24.1 bar), typically about 200-280 psi (e.g., about 13.8-19.3 bar).

Typically, the composition may be provided in a container, typically a sealed container, e.g., a canister.

Advantageously, providing the sprayable composition as a pressurized composition in a sealed container may promote, facilitate, and/or help mixing of the flammability reducer with the composition, e.g., adhesive composition. Such mixing under pressure may provide the advantageous effect of reducing the flammability of the sprayable composition, while mitigating, minimizing, or avoiding any problem associated with its high volatility. Advantageously also, the present method may reduce or avoid the need to provide expensive or impractical mixing means to mix the flammability reducer with the adhesive composition.

Certain flammability reducers, such as trans-1-chloro-3,3,3-trifluoropropene (Solstice® PF-C) typically are highly volatile. This makes these compounds difficult to mix in a composition, such as an adhesive composition, without them evaporating. Thus, the inventors have discovered a new process for preparing a sprayable, non-flammable, solvent-based composition.

The sprayable composition may be as described in relation to the first aspect.

Thus, according to an embodiment of the second aspect, there is provided a sprayable composition comprising: a composition including at least one core component and at least one solvent, where the at least one core component includes at least one polymer or resin and where the solvent includes transdichloroethylene; a flammability reducer including trans-1-chloro-3,3,3-trifluoropropene; and a gas propellant including carbon dioxide.

Features described above in respect of the method according to the first aspect are equally applicable to the composition according to the second aspect, and are not repeated herein merely for reasons of brevity.

According to a third aspect of the present disclosure there is provided a kit for storing a sprayable composition comprising: a container; and a sprayable composition provided inside the container, the sprayable composition comprising: a composition including at least one core component and at least one solvent, where the at least one core component includes at least one polymer or resin and where the solvent includes transdichloroethylene; a flammability reducer including trans-1-chloro-3,3,3-trifluoropropene; and a gas propellant including carbon dioxide.

The sprayable composition may be as described in relation to the first aspect or the second aspect.

The container, e.g., canister, may further include a dispensing means for dispensing the sprayable composition, such as one or more of a nozzle, a trigger, an outlet tube, etc. Thus, the kit may include a kit for dispensing, e.g., spaying, a sprayable composition.

Features described above in respect of the method according to the first aspect or the composition according to the second aspect are equally applicable to the kit according to the third aspect, and are not repeated herein merely for reasons of brevity.

For the avoidance of doubt, any feature described in respect of any aspect of the present disclosure may be applied to any other aspect of the present disclosure, in any appropriate combination. For example, apparatus features may be applied to method features and vice versa.

### BRIEF DESCRIPTION OF THE DRAWINGS

The present disclosure will now be further described in detail and with reference to the figures in which:

FIG. 1 illustrates a canister according to a first embodiment, in accordance with one or more embodiments of the present disclosure.

FIG. 2 illustrates an embodiment of a set-up useful to implement a method according to a second embodiment, in accordance with one or more embodiments of the present disclosure.

FIG. 3 illustrates an embodiment of a set-up useful to implement a method according to a second embodiment, in accordance with one or more embodiments of the present disclosure.

FIG. 4 illustrates a simplified block diagram of a reactive polymer canister system, in accordance with one or more embodiments of the present disclosure.

FIG. 5 illustrates a perspective view of the reactive polymer canister system, in accordance with one or more embodiments of the present disclosure.

FIG. 6 illustrates a dispensing sub-system of the reactive polymer canister system, in accordance with one or more embodiments of the present disclosure.

FIG. 7 illustrates a trolley for the reactive polymer canister system, in accordance with one or more embodiments of the present disclosure.

FIG. 8 illustrates a backpack for the reactive polymer canister system, in accordance with one or more embodiments of the present disclosure.

### DETAILED DESCRIPTION

The present disclosure has been particularly shown and described with respect to certain embodiments and specific features thereof. The embodiments set forth herein are taken to be illustrative rather than limiting. It should be readily apparent to those of ordinary skill in the art that various changes and modifications in form and detail may be made without departing from the spirit and scope of the disclosure.

Reference will now be made in detail to the subject matter disclosed, which is illustrated in the accompanying drawings.

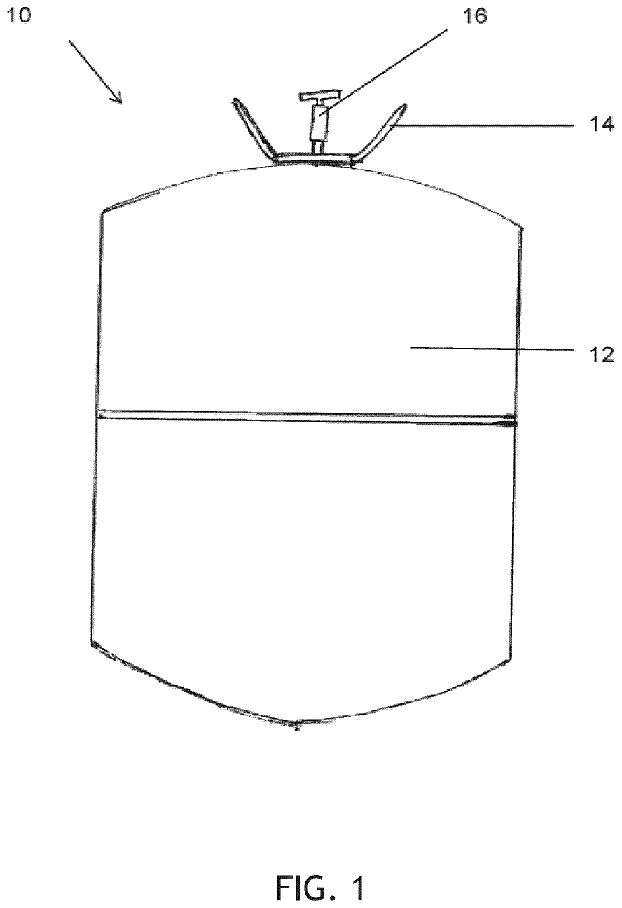

FIG. 1 shows a canister 10 according to a first embodiment. The canister 10 has a canister body 12, a handle 14, and a valve 16. The canister 10 represents a typical embodiment of a canister suitable to receive a sprayable composition according to the present invention.

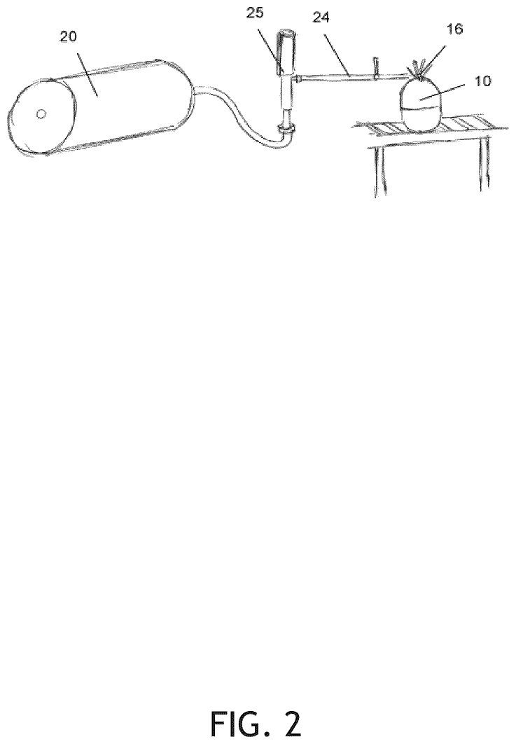

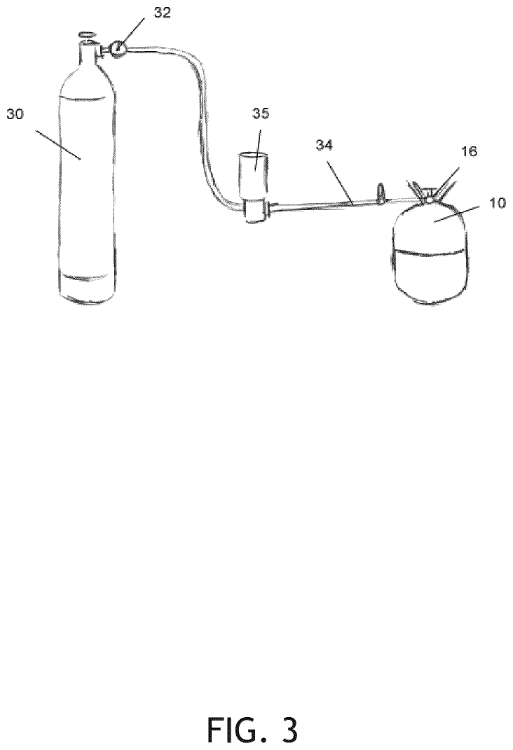

FIGS. 2 and 3 show an embodiment of a set-up useful to implement a method according to a second embodiment, as described in more detail in the examples below.

### EXAMPLES

### Materials

### Adhesive

Adhesives used in the following examples were:
SIS elastomer marketed as Vector® 4255 from TSRC, Inc.®;
SIS elastomer marketed as Vector® 4411 from TSRC, Inc.®.

### Solvent

The solvent used in the following examples was Transdichloroethylene (marketed as 1,2-Transdichloroethylene from Samuel Banner & Co Ltd).

### Flammability Reducer

The flammability reducer used in the following examples was trans-1-chloro-3,3,3-trifluoropropene marketed a Solstice® PF-C by Honeywell®.

### Gas Propellant.

The gas propellant used in the following examples was carbon dioxide. Carbon dioxide was supplied in 1491 kg tanks procured from Air Products and Chemicals, Inc.

### Method

A 22.1 L canister 10, as shown in FIG. 1, was used in this example.

In a drum were mixed approximately 30 kg of adhesive and approximately 65 kg of transdichloroethylene solvent.

Upon dissolution of the adhesive in the solvent, 7 kg of the adhesive composition was transferred into the canister 10.

The canister 10 was sealed.

The flammability reducer was then added to the canister. To do this, as shown in FIG. 2, the canister inlet valve 16 was connected to a container 20 of trans-1-chloro-3,3,3-trifluoropropene via a tube connection 24. Approximately 1 kg of trans-1-chloro-3,3,3-trifluoropropene was then pumped into the canister 10 via a pump 25.

The canister 10 was then pressurized using carbon dioxide (CO₂). As shown in FIG. 3, the canister inlet valve 16 was connected to a carbon dioxide cylinder 30 equipped with a measuring gauge 32, via a tube connection 34. Approximately 1 kg of carbon dioxide was then injected into the canister 10 via a regulator 35, leading to a pressure inside the canister 10 of approximately 250 psi (e.g., 17.2 bar).

In a further aspect of the present disclosure, there has been increasing pressure from national and state regulatory bodies to reduce or eliminate propellants or blowing agents that have high global warming potential (GWP). For example, many current materials are urethane foam products, packaged in pre-pressurized canisters, which utilize hydrofluorocarbon (HFC) materials, which have high GWP. There has been international pressure to change the use of HFC materials for lower GWP propellants, like hydrofluoroolefins (HFOs). However, implementation of HFOs in pre-pressurized canisters has proven difficult. As such, it would be beneficial to incorporate a propellant or blowing agent with low GWP that is easily incorporated in pre-pressurized canister systems.

Embodiments of the present disclosure are directed to a reactive polymer canister system for quickly and easily applying/dispensing one or more materials using one or more low GWP propellants/blowing agents. For example, the reactive polymer canister system may be used to apply or dispense one of latex, silicone, one or more polymers, or the like. By way of another example, the reactive polymer canister system may be used to apply or dispense one or more urethane foams using one or more low GWP propellants/blowing agents. For instance, the reactive polymer canister system may be used to apply or dispense one or more urethane foams for applications such as, but not limited to, roofing adhesive, structure insulation, sport surface bonding, or the like.

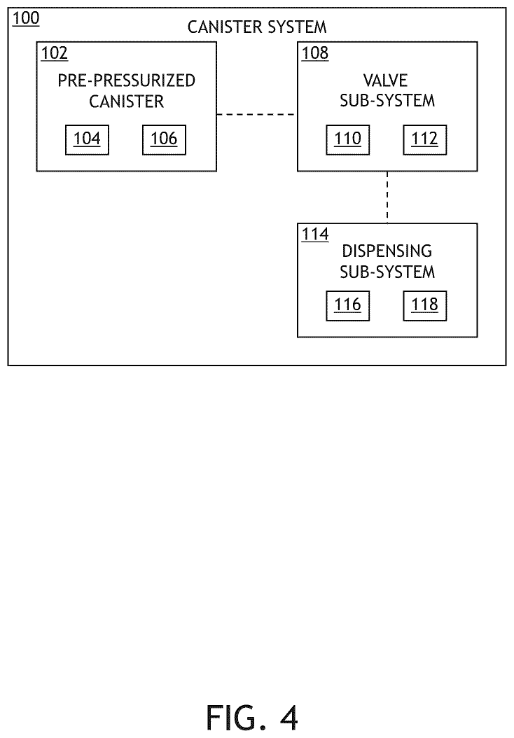

FIGS. 4-8 generally illustrate a reactive polymer canister system 100, in accordance with one or more embodiments of the present disclosure.

The canister system 100 may include a pressurized canister 102. For example, the pressurized canister 102 may include a pre-pressurized canister. For purposes of the present disclosure, the term “pre-pressurized” may mean a canister that is pressurized and filled with the desired contents (e.g., polymeric material(s) and low GWP propellant/blowing agent) prior to sealing the canister for use. It is noted that the pre-pressurized canister 102 may eliminate the need for a compressor to reduce the weight of the system 100 to allow for easy transportation. Further, it is noted that the pre-pressurized canister 102 may eliminate the need for an external power source to operate the system (e.g., air, electricity, or the like). This allows the canister system 100 to be used in areas that are not easily accessible to power sources such as, but not limited to, athletic fields, sporting events, convention centers, large warehouses, schools, office buildings, retail stores, grocery stores, or the like.

The pressurized canister 102 may be configured to contain one or more materials 104. For example, the pressurized canister 102 may be configured to contain one or more polymeric materials. The one or more polymeric materials may include any polymeric material such as, but not limited to, polyurethane, polyisocyanurate, silicone, modified silicone (MS), silyl terminated polyether polymer, silylated polyurethane resin (SPUR), silane terminated polyurethane (STP), latex, latex-acrylic, or the like, or a combination thereof.

The pressurized canister 102 may be further configured to contain one or more low GWP propellants 106 (or blowing agents 106). For example, the one or more low GWP propellants 106 may be configured to dispense the one or more materials. By way of another example, the one or more propellants may be used as a blowing (foaming) agent to dispense the one or more materials. The one or more propellants may include, but are not limited to, carbon dioxide, nitrogen, trans-1-Chloro-3,3,3-trifluoropropene (e.g., 1233zd), 1,1,1,2-Tetrafluoroethane (134a), trans-1,3,3,3-Tetrafluoroprop-1-ene (1234ze), 1,1-Difluoroethane (152a), propane, isobutane, butane, dimethyl ether (DME), or the like; or a combination thereof.

The pressurized canister 102 may include any amount of pressure suitable for applying or dispensing the one or more materials. For example, the pressurized canister may be pre-pressurized at 10 PSI. Further, it is noted herein that the pressurized canister may be any size. For example, the pressurized canister may be 22.0 Liters. By way of another example, the pressurized canister may be 7.0 Liters.

The pressurized canister 102 may contain any percentage (or ratio) of the one or more polymeric materials 104 and the one or more low GWP propellants 106 (or blowing agents 106). For example, the pressurized canister 102 may include between 3% to 50% of the propellant by weight of the total formulation. For instance, the pressurized canister 102 may include between 5% to 15% propellant by weight of the total formulation. By way of another example, the pressurized canister may include any combination and/or ratios of one or more polymeric materials and at least one propellant for specific products. For instance, the specific products may include, but are not limited to, single component, moisture or UV cure systems; pre-polymerized or in-can polymerized, or could be plural component, polymer-and-catalyst material.

The canister system 100 may include a valve sub-system 108. The valve sub-system 108 may include dispensing valve 110. For example, the dispensing valve 110 may include a threaded fitting. By way of another example, the dispensing valve 110 may include a quick connect fitting. The dispensing valve 110 may couple to a portion of the dispensing sub-system 114 to dispense the one or more polymeric materials. Further, the valve sub-system 108 may couple to the pressurized canister 102 via any mechanism known in the art suitable for pressurized canisters.

The valve sub-system 108 may further include a knob or lever 112 configured to regulate the pressure of the pressurized canister 102 such that the one or more polymeric materials contained within the pressurized canister 102 may be released. The valve sub-system 108 may further include a cap or stop configured to prevent the dispensing valve 110 from leaking.

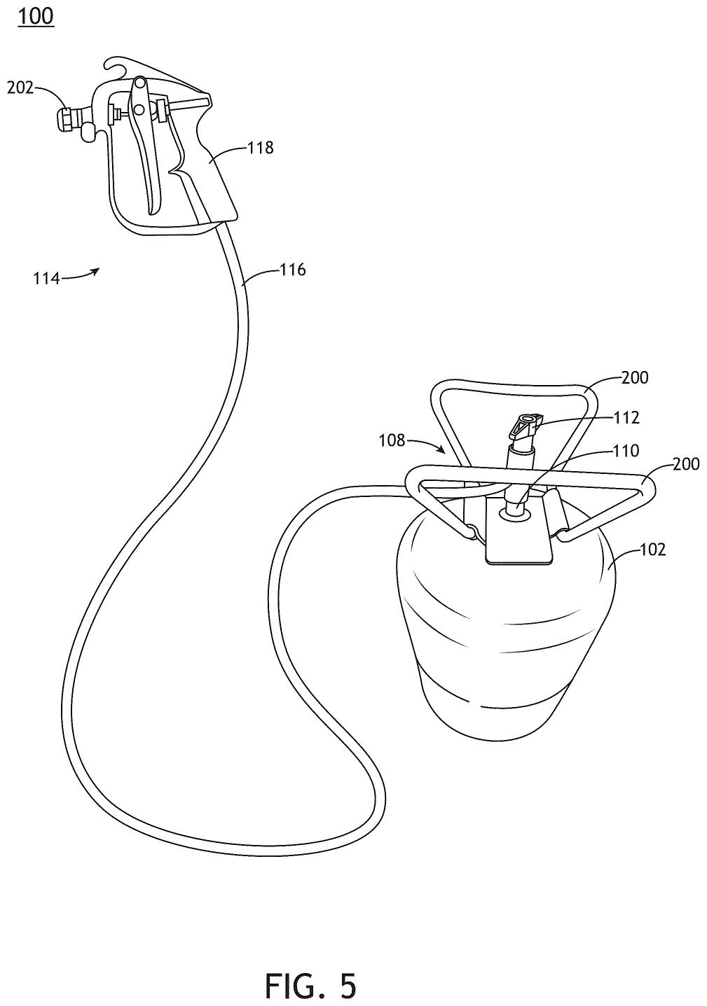

Although FIGS. 4-5 illustrate a specific valve assembly configuration, it is noted herein that the valve assembly may include any valve assembly known in the art of pressurized canisters.

The canister system 100 may include a dispensing sub-system 114 configured to couple to a portion of the valve sub-system 108. The dispensing sub-system 114 may include a dispensing hose 116 and a dispensing member 118. For example, a proximate end of the dispensing hose 116 may couple to the valve sub-system 108 and a distal end of the dispensing hose 116 may couple to the dispensing member 118, such that the one or more polymeric materials and the one or more propellants may be dispensed through a portion of the dispensing member 118. The dispensing hose 116 may be formed of any material known in the art. For example, the dispensing hose 116 may be formed of, but is not required to be formed of, rubber, nylon, Teflon™, polyethylene, polypropylene, or the like.

Further, the dispensing sub-system 114 may include a dispensing member 118 configured to directly couple to a portion of the valve sub-system 108.

The one or more polymeric materials may be configured to exit the pre-pressurized canister via the dispensing hose when the dispensing member dispenses the one or more polymeric materials. The dispensing sub-system 114 may be configured to dispense the one or more polymeric materials using any technique known in the art. For example, the dispensing sub-system 114 may dispense the one or more polymeric materials via foaming, spraying, liquid stream, fogging, misting, electrostatic transfer, or the like.

The dispensing sub-system 114 may include any dispensing member 118 known in the art. For example, as shown in FIG. 3, the dispensing sub-system 114 may include a spray gun (e.g., gunjet spray gun). By way of another example, the dispensing sub-system 114 may include a ball valve. By way of another example, the dispensing sub-system 114 may include a thumb trigger valve. By way of another example, the dispensing sub-system 114 may include an air-operated valve. By way of another example, the dispensing sub-system 114 may include a solenoid operated valve. It is noted herein that the dispensing sub-system 114 may include any dispensing member, therefore the above discussion should not limit the scope of present disclosure.

The dispensing sub-system 114 may further include one or more dispensing tips 202. For example, the dispensing sub-system 114 may include, but is not required to include, one or more flat fan tips, cone spray tips, stream control tips, parabolic spay tips, or the like.

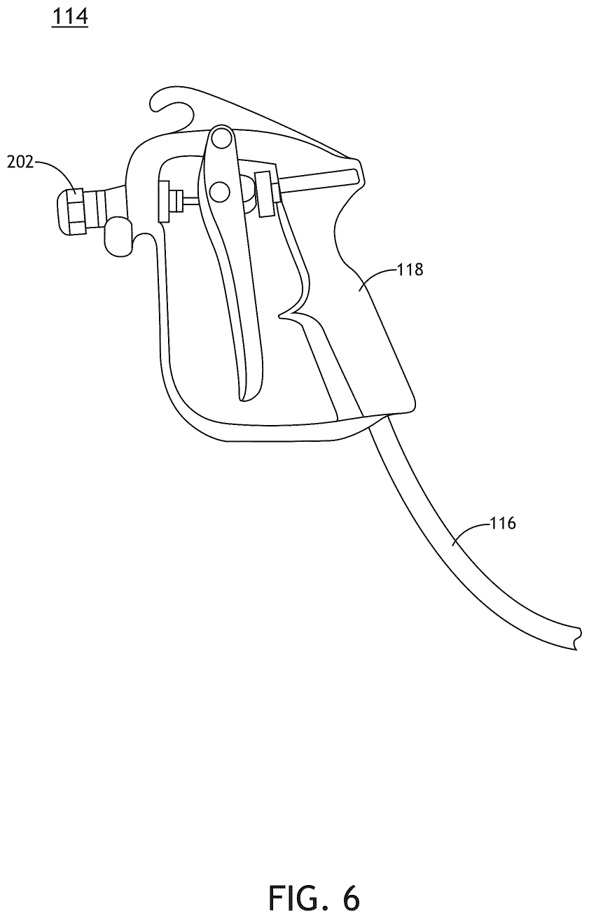

The control of the dispensing may occur in serval different ways. For example, the spray application may be manual via a spray gun (e.g., the spray gun shown in FIG. 6) or a wand. By way of another example, the spray (or stream) application may be automated via an electronic eye, electronic controller, solenoid valve, or the like. By way of another example, the dispensing may be operated via a foot-pedal operation using a mechanism connecting the foot pedal to the dispensing valve of the dispensing sub-system 114. By way of a further example, the dispensing may be operated via lever actuation using an object (e.g., a hand, or the like) to pass under the dispensing member 118 of the dispensing sub-system 114.

Referring back to FIG. 5, the canister system 100 may include one or more handles 200. The one or more handles 200 may be configured to allow a user to easily transport the canister system 100. Although FIG. 2 illustrates a specific size, shape, and configuration of the one or more handles 200, it is contemplated that the canister system 100 may include any size, shape, and/or configuration of the one or more handles 200.

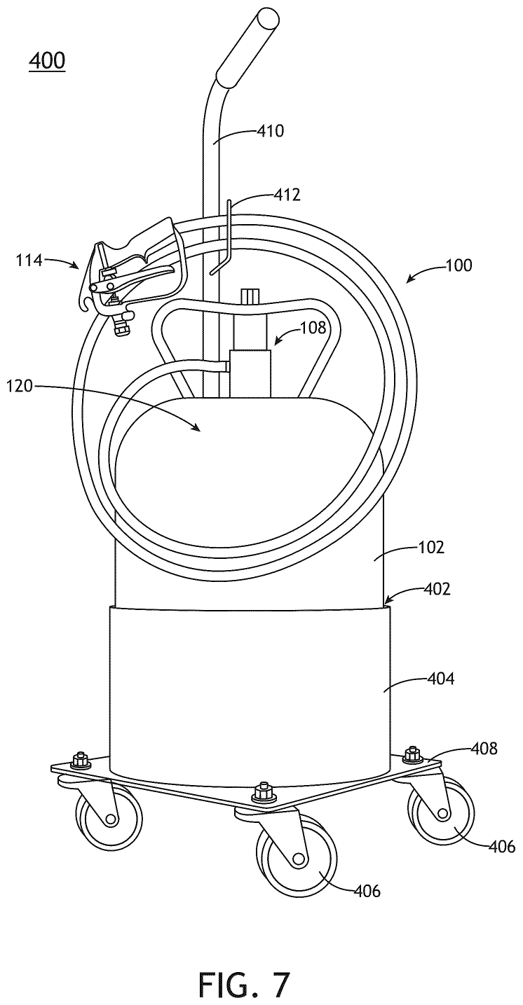

Referring to FIG. 7, the canister system 100 may be configured to couple to a trolley assembly 400 configured to aid in transporting the canister 102.

The trolley assembly 400 may include a cavity 402 defined by one or more sidewalls 404. The cavity 402 may be configured to house the canister system 100. For example, the shape of the cavity 402 may be complementary to the shape of the canister 102 of the system 100.

The trolley assembly 400 may further include one or more wheels 406 coupled to a base 408 of the trolley assembly 400. The one or more wheels 406 may be configured to allow a user to easily transport the canister system 100 around to the one or more desired areas.

The trolley assembly 400 may further include a handle 410 coupled to the base 408 of the trolley assembly 400. The handle 410 may also be coupled to a portion of the one or more sidewalls 404 of the trolley assembly 400. The handle 410 may allow a user to transport the trolley assembly including the canister system 100 to one or more desired areas. The handle 410 may further include one or more grip bands. For example, the handle 410 may include one or more non-slip grip bands.

The handle 410 may include one or more hooks 412 configured to hold a portion of the dispensing sub-system 114. For example, the dispensing hose 116 of the dispensing sub-system 114 may couple to the one or more hooks 412 such that the dispensing hose 116 does not interfere with the transportation or use of the canister system 100.

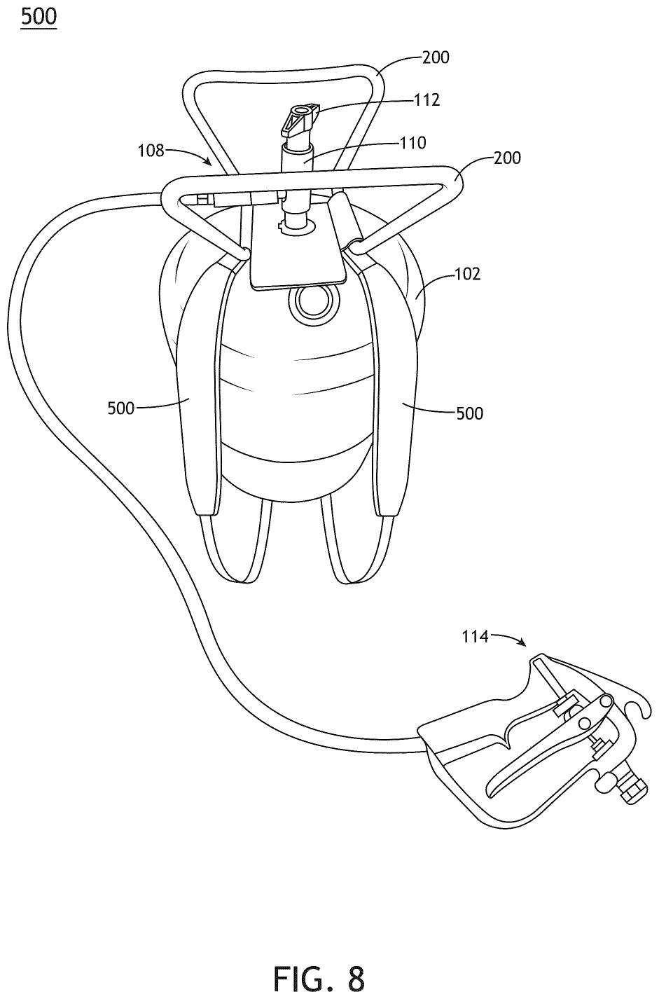

Referring to FIG. 8, the canister system 100 may be configured to couple to one or more straps 500. For example, the canister system 100 may be used as a backpack via the one or more straps. By way of another example, the canister system 100 may be carried using a cross-body strap.

It is contemplated herein that the pressurized canister 102 may include an internal bag (not shown) configured to hold the one or more polymeric materials and the one or more propellants. The internal bag may be configured to prevent an interior surface of the pressurized canister from rusting.

After significant testing, it is contemplated that the following low GWP formulations were developed and tested for peel strength, the ability to be sprayed effectively, and within a low GWP threshold.

### Formula 1:

Adhesive concentrate: 90%
HFO 1233zd: 4%
CO₂: 6%
Nitrogen pressure: 300 psi

### Formula 2:

Adhesive concentrate: 91%
CO₂: 9%
Nitrogen Pressure: 250 psi

It is contemplated that the formulations may vary from 1% to 20% CO₂, and from 0.5% to 40% 1233zd. In an embodiment, a preferred formulation may include 5% to 12% CO₂, and no 1233zd (e.g., 0% 1233zd), or as little as possible, such as around 1% to 3%.

It is further contemplated that any fluorinated propellant/solvent, such as Asahikilin® AE-3000, Amolea® AS300, Chemours® Vertrel®, 3M® Novec®, may be employed in in place of HFO 1233zd.

It is further contemplated that the only propellant may be CO₂ and Nitrogen or a combination of CO₂ and an HFO or HCFO with Nitrogen in the formula.

### Formula 3:

Adhesive concentrate: 88%
HFO 1234ze: 6%
CO₂: 6%
Nitrogen pressure: 300 psi

Further, it is contemplated that the canister system 100 be configured to be contained within a dispensing cabinet or housing. For example, the canister system 100 may be configured to be housed within a box (e.g., a cardboard box). The dispensing cabinet may include one or more advertisements. Further, the dispensing cabinet may include promotional information. The dispensing cabinet may be configured to hold electronics and/or mechanical apparatuses to aid in the dispensing of the one or more polymeric materials.

It is believed that the inventive concepts disclosed herein and many of their attendant advantages will be understood by the foregoing description of embodiments of the inventive concepts disclosed, and it will be apparent that various changes may be made in the form, construction, and arrangement of the components thereof without departing from the broad scope of the inventive concepts disclosed herein or without sacrificing all of their material advantages; and individual features from various embodiments may be combined to arrive at other embodiments. The form herein before described being merely an explanatory embodiment thereof, it is the intention of the following claims to encompass and include such changes. Furthermore, any of the features disclosed in relation to any of the individual embodiments may be incorporated into any other embodiment.

What is claimed:

1. A reactive polymer canister system comprising:
a pre-pressurized canister, the pre-pressurized canister being pre-filled with one or more polymeric materials and one or more low global warming potential (GWP) propellants, the one or more low GWP propellants including at least one of carbon dioxide, nitrogen, or trans-1-Chloro-3,3,3-trifluoropropene;
a valve sub-system, the valve sub-system including a dispensing valve configured to couple to a portion of the pre-pressurized canister, the valve sub-system including a valve control mechanism configured to regulate a pressure of the pre-pressurized canister to cause the pre-pressurized canister to release the one or more polymeric materials; and
a dispensing sub-system, the dispensing sub-system configured to fluidically couple the pre-pressurized canister to the valve sub-system, the dispensing sub-system comprising:
a dispensing hose, the dispensing hose coupled to a portion of the dispensing valve; and
a dispensing member, the dispensing member coupled to a portion of the dispensing hose, the dispensing member configured to dispense the one or more polymeric materials contained within the pre-pressurized canister.

2. The reactive polymer canister system of claim 1, wherein the pre-pressurized canister includes between 3% to 50% by weight propellant.

3. The reactive polymer canister system of claim 2, wherein the pre-pressurized canister includes between 5% to 15% by weight propellant.

4. The reactive polymer canister system of claim 1, wherein the one or more low GWP propellants include the trans-1-Chloro-3,3,3-trifluoropropene.

5. The reactive polymer canister system of claim 1, wherein the one or more polymeric materials include at least one of:
polyurethane, polyisocyanurate, silicone, modified silicone (MS), silyl terminated polyether polymer, silylated polyurethane resin (SPUR), silane terminated polyurethane (STP), latex, or latex-acrylic.

6. The reactive polymer canister system of claim 1, wherein the dispensing member is configured to couple to a dispensing tip.

7. A pre-pressurized canister comprising:
one or more polymeric materials and one or more low global warming potential (GWP) propellants, the one or more low GWP propellants including at least one of carbon dioxide, nitrogen, or trans-1-Chloro-3,3,3-trifluoropropene.

8. The pre-pressurized canister of claim 7, wherein the pre-pressurized canister is configured to couple to a dispensing sub-system, the dispensing sub-system configured to dispense the one or more polymeric materials contained within the pre-pressurized canister.

9. The pre-pressurized canister of claim 7, wherein the pre-pressurized canister includes between 3% to 50% by weight propellant.

10. The pre-pressurized canister of claim 9, wherein the pre-pressurized canister includes between 5% to 15% by weight propellant.

11. The pre-pressurized canister of claim 7, wherein the one or more low GWP propellants include the trans-1-Chloro-3,3,3-trifluoropropene.

12. The pre-pressurized canister of claim 7, wherein the one or more polymeric materials include at least one of:
polyurethane, polyisocyanurate, silicone, modified silicone (MS), silyl terminated polyether polymer, silylated polyurethane resin (SPUR), silane terminated polyurethane (STP), latex, or latex-acrylic.

13. A chemical composition comprising:
one or more polymeric materials; and
one or more low global warming potential (GWP) propellants, the one or more low GWP propellants including trans-1-Chloro-3,3,3-trifluoropropene,
the chemical composition including between 3% to 50% by weight propellant.

14. The chemical composition of claim 13, wherein the chemical composition includes between 5% to 15% by weight propellant.

15. The chemical composition of claim 13, wherein the one or more polymeric materials include at least one of:
polyurethane, polyisocyanurate, silicone, modified silicone (MS), silyl terminated polyether polymer, silylated polyurethane resin (SPUR), silane terminated polyurethane (STP), latex, or latex-acrylic.
